(19) United States
(12) Patent Application Publication
(10) Pub. No.: US 2023/0232449 A1
(43) Pub. Date: Jul. 20, 2023

(54) COMMUNICATING BETWEEN APPARATUS IN THE UNLICENSED SPECTRUM

(71) Applicant: Nokia Technologies Oy, Espoo (FI)

(72) Inventors: Adrian Jose Garcia Rodriguez, Santa Cruz de Tenerife (ES); Mika Kasslin, Espoo (FI); Lorenzo Galati Giordano, Dublin (IE); Olli Alanen, Vantaa (FI); Claudio Rosa, Randers (DK); Nuno Kiilerich Pratas, Gistrup (DK)

(73) Assignee: Nokia Technologies Oy, Espoo (FI)

(21) Appl. No.: 18/007,847

(22) PCT Filed: Jun. 4, 2020
(86) PCT No.: PCT/EP2020/065528

§ 371 Date: Dec. 2, 2022

(51) Int. Cl. H04W 74/08; H04W 16/14

(52) U.S. Cl. CPC H04W 74/0808; H04W 16/14

(57) ABSTRACT

A method of communicating between nodes on a plurality of channels within the unlicensed spectrum is disclosed where coordination of the acquiring of the different channels is provided so that a further channel is acquired prior to the occupancy time of the currently used channel expiring. The method involves determining at one node that a channel in the unlicensed band has been acquired for a predetermined occupancy time. Initiating a scan of at least one further channel within the unlicensed spectrum to determine if a further channel is available. Once a predetermined time has passed and within the predetermined occupancy time, acquiring the available channel by transmitting a signal on it.

### TECHNOLOGICAL FIELD

Various example embodiments relate to communications within the unlicensed spectrum.

### BACKGROUND

The unlicensed spectrum provides an opportunity to increase the bandwidth available for signals to be transmitted. However, as this bandwidth is shared with other devices scanning may be required prior to transmission to reduce interference. Furthermore, there may be rules regarding how often a device can scan to allow the spectrum to be fairly shared and these issues can lead to increased latency.

The unlicensed band is divided into sub-bands or channels each covering a certain frequency band and scanning procedures such as listen before talk involves the sensing of a channel to determine whether it is available prior to transmitting a signal. Where it is available the channel may be acquired by the node for a channel occupancy time COT. During this time signals may be sent and other nodes are deterred from using the channel.

Increasingly devices are able to transmit and receive on more than one channel and this may be used to increase throughput and/or increase reliability. A potential problem may arise with discontinuities in communication when the occupancy period in one channel expires and a further channel is to be acquired.

It would be desirable to provide a system for communicating in the unlicensed spectrum in a manner which is both efficient and allows coexistence with other systems.

### BRIEF SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to various, but not necessarily all, embodiments of the invention there is provided according to a first aspect a method performed at an apparatus, said method comprising: determining at said apparatus that a channel in the unlicensed spectrum has been acquired by said apparatus or by a further apparatus for a predetermined occupancy time, said channel being one of a plurality of channels within said unlicensed spectrum; initiating a scan of at least one further channel within said unlicensed spectrum to determine if said scanned at least one further channel is available; determining whether a predetermined time has elapsed since said channel was acquired, said predetermined time being less than or equal to said predetermined occupancy time; and in response to said scan indicating that at least one of said scanned at least one further channels is available, and when said predetermined time is determined to have elapsed initiating the acquiring of one of said available scanned channels for a predetermined occupancy time.

The use of the unlicensed spectrum may require scanning of the channels before use to allow for coexistence between different devices using the spectrum. This scanning increases latency and can be a particular problem where the scanning process requires a device to wait until the unlicensed medium is idle for a regulatory specified period of time which may be quite long if there are large numbers of devices in the neighbourhood before attempting to access the spectrum. This is the case with listen before talk for example.

The inventors recognised that there are many channels within the unlicensed spectrum that could be used for communication and that there are devices that increasingly support multi-link modes of operation. Embodiments seek to take advantage of this ability to transmit on different channels while addressing the problems that may arise when communications switch between channels, particularly where a requirement to wait for a channel to be available has to be met.

Thus, an aspect provides a method which commences the scan of one or more further channels within the unlicensed spectrum while a first channel that has been acquired for an occupancy period is being used for communication between two apparatus. Once the scan has indicated that there is a channel that is available, rather than acquiring that channel immediately, the method waits until a predetermined time has elapsed since the first channel was acquired and only at that point will the further channel be acquired. In this way, there is coordination between the acquiring of the different channels, and the acquiring of a next channel to be used for the communication can be controlled to be within the occupancy time of the first channel such that any gaps and associated discontinuous communication will be inhibited.

In some embodiments, said method comprises prior to initiating said scan determining whether a second predetermined period of time has elapsed since said channel was acquired, and when said second predetermined time is determined to have elapsed initiating said scan, said second predetermined period of time being shorter than said predetermined period of time.

Although, the scan may be performed in the background for many of the channels for much of the time, in some embodiments it is performed at a set time. This time may be selected as a certain amount of time after the first channel has been acquired, or as a certain amount of time before it is determined that the occupancy time will expire, or a certain amount of time before it is determined to be desirable for a new occupancy period to start. In this regard, the subsequent channel is required before the occupancy period of the first channel expires, but only shortly before. Furthermore, if the scan of the channel indicates the channel to be available some time before it is required, the chances of it no longer being available at the required time increases. However, the channels that are scanned may not be available initially and many scanning methods such as listen before talk have back off periods of time if the channel is not available and thus, the amount of time required for the scan is not completely predictable. Thus, it may be advantageous to wait for a certain amount of time before beginning the scan, and the preferred amount of time to wait may be dependent upon conditions.

In some embodiments, a value of said second predetermined period of time is specific to a particular channel.

The amount of time required to scan and find an available channel is not predictable and will be affected by the channel loading and channel occupancy among other things and thus, it will be specific to a particular channel and in some cases the second predetermined period of time may depend on the channel being scanned. In other cases it may be a simpler matter to use a set second determined period of time for all channels.

In some embodiments, said method comprises determining said second predetermined time for said at least one further channel to be scanned in dependence upon at least one of:
a determined channel load and channel occupancy of said at least one further channel; and
stored historical data indicative of a latency between a scan commencing and said at least one further channel being determined to be available.

As noted previously, the time required for a scan will depend on a number of factors that may be specific to the channel and the conditions prevailing for that channel. Thus, it may be advantageous for it to be specific to a particular channel and/or to be determined based on historical data for that channel and/or on a determined channel load and channel occupancy.

In this way, the second predetermined time period can be selected to be dependent upon the properties of the channel being scanned, said apparatus selecting a shorter second predetermined time to provide a potentially longer scanning time where a channel load and occupancy is determined to be high. In some embodiments, the second predetermined time maybe estimated for a plurality of channels and one value selected for all, the value being estimated such that it is very likely that at least one of the channels will be available within that period of time.

In some embodiments, said predetermined time is selected in dependence upon a desired overlap of said occupancy times.

In some embodiments, said predetermined time depends upon the network loading and may be controlled to lie within a particular percentage range of the occupancy time, in some embodiments, said predetermined time comprises between 70 and 99.5% of the occupancy time.

The predetermined time between the current channel being acquired and the acquiring of a subsequent channel will affect the overlap of the occupancy times which occurs when both channels have been acquired by the apparatuses. In this regard, in many cases it may be desirable for there to be very little overlap in occupancy times, as low overlap provides efficient use of the channels and allows for a greater amount of time for the scanning of subsequent available channels. However, depending on the apparatuses and the type of communication some overlap may be advantageous and may lead to an increased chance of there being no gaps in the communication. In one example, the desired overlap may be selected in dependence upon a buffer size of the apparatus and the further apparatus.

The second predetermined time may also be selected in dependence upon the desired overlap as any overlap will affect the amount of scanning time that is available. In some cases, the second predetermined time may be selected in dependence upon the predetermined time, which itself may be dependent on the desired overlap. In this regard the amount of scanning time available will depend on the difference between the predetermined time and the second predetermined time, and thus, where the preferred scanning time remains the same, changes in the predetermined time, due to changes in desired overlap may trigger the same changes in the second predetermined time.

In some embodiments, said apparatus performs an initial step of at least one of:
initiating transmission of an indication to said further apparatus that multiple channel communication within the unlicensed spectrum between said apparatus and said further apparatus is to be performed; and
receiving an indication from said further apparatus that multiple channel communication within the unlicensed spectrum between said apparatus and said further apparatus is to be performed.

Prior to multilink communication occurring between the apparatus and further apparatus an agreement that such a communication is to occur will often need to be made. This may happen by one apparatus sending a request for multiple link communication and the other apparatus accepting the multiple link communication request and/or it may be done by configuration signals that configure the apparatuses for multiple link communication. In this regard, each apparatus should recognise that they are operating in this way such that they scan a plurality of channels that the other apparatus may be transmitting on.

In some embodiments, said step of determining at said apparatus that a channel in the unlicensed spectrum has been acquired by said apparatus or by said further apparatus comprises acquiring said channel, said method further comprising:

repeating said steps of scanning channels and acquiring available scanned channels for a predetermined occupancy time a plurality of times during a period of multiple channel communication between said apparatus and said further apparatus.

Although, the step of acquiring the channel may be done by each of the apparatuses in the communication link, in some embodiments, there may be a controlling apparatus for example a gNB and in this case, it may act to acquire the channels each time that the channel switch occurs. Thus, it controls the scanning and acquiring of the multiple channels and any overlap of the occupancy times.

In some embodiments, said method further comprises:
on acquiring said one of said available scanned channels, requesting an uplink transmission from said further apparatus; and
where said uplink transmission is not received within a set time:
   selecting a further one of said scanned available channels and acquiring said further one of said scanned available channels for a predetermined occupancy time period; and
   marking said one of said available scanned channels as unavailable.

In some embodiments, such as where one apparatus is a gNB then there may be different apparatuses such as user equipment communicating with the gNB and the channel that is acquired for the communication may not be particularly appropriate for one of these apparatuses, where for example there are hidden devices. Thus, it may in some cases be advantageous if a signal is transmitted initially requesting a response. Where a response is not received within a certain period then this is indicative of the apparatus not receiving the signal and a further, alternative channel may be acquired.

In some embodiments, said predetermined time is selected to provide a set overlap period for said occupancy times, said step of selecting and acquiring said further one of said scanned available channels being performed within said set overlap period.

Where there is a step of determining if the selected channel is appropriate then it may be advantageous for the apparatuses to operate with an occupancy overlap period that is set to be long enough for the test procedure of determining whether or not the acquired channel is appropriate for the other apparatus to be performed within this period. In this way where another channel is required, this can be selected within the occupancy overlap period without a gap in communication arising. The scanned channel that was not appropriate may be marked as unavailable such that this does not occur again. In this regard this may be for a predetermined time or for a particular apparatus or set of apparatuses.

In some embodiments, said step of determining at said apparatus that a channel in the unlicensed band has been acquired by said apparatus or by said further apparatus for a predetermined occupancy time comprises receiving a signal from said further apparatus indicating that said further apparatus has acquired said channel.

In some embodiments apparatuses may take it in turns to acquire channels and thus, following receiving communications from an apparatus indicating that that apparatus has acquired a channel, the receiving apparatus may scan one or more other channels within the unlicensed spectrum and acquire one of these during the occupancy period of the previously acquired channel and this channel can then be used for a subsequent portion of the communication. This process is repeated with each receiving apparatus scanning for an available channel for a subsequent portion of the communication. This may occur where one apparatus is, for example, an access point in a Wi-Fi system and the other may be a user equipment.

In some embodiments, the method comprises following acquiring said scanned available channel transmitting an indication to said further apparatus that said scanned available channel has been acquired for a predetermined occupancy time; and

receiving a signal from said further apparatus indicating that said further apparatus has acquired a further one of said plurality of channels in the unlicensed spectrum prior to or on said predetermined occupancy time that said scanned available channel was acquired for expiring.

As noted above, the apparatus and further apparatus may take it in turns to acquire the channels and to scan for a further channel during the occupancy time of the previously acquired channel.

In some embodiments the method further comprises performing a further check that said scanned available channel is still available immediately prior to initiating the acquiring of said channel

Where the scan of the channel indicating the channel to be available occurs a little time before the predetermined time has elapsed, then when the time is about to elapse and the channel should be acquired, a further check may be required to ensure that the channel is still available. This further check is generally significantly quicker than the previous scan as there will be no back off period, and the check may be simple scan to check for any signals. This may be done a certain set time before the predetermined time elapses, this certain set time being close to the end of the predetermined time such that the channel can be acquired immediately if it is determined to still be clear. In this regard the second predetermined time that sets the start of the scan relative to the end of the occupancy period is chosen so that it is estimated that the scan should complete close to the end of the occupancy time and it is therefore unlikely that the channel will not be clear. However, if it is not clear, then another channel needs to be acquired, or the system needs to check again.

According to various, but not necessarily all, embodiments of the invention there is provided according to a second aspect a computer program comprising computer readable instructions which when executed by a processor on an apparatus are configured to cause said apparatus to perform a method according to a first aspect.

According to various, but not necessarily all, embodiments of the invention there is provided according to a third aspect an apparatus comprising means configured to:
determine that a channel in unlicensed spectrum has been acquired by said apparatus or by a further apparatus for a predetermined occupancy time, said channel being one of a plurality of channels within said unlicensed spectrum;
initiate scanning of at least one further channel within said unlicensed spectrum to determine if said scanned at least one further channel is available;
determine whether a predetermined time has elapsed since said channel was acquired, said predetermined time being less than or equal to said predetermined occupancy time; and
following said scan indicating that at least one of said scanned at least one further channels is available, and when said predetermined time is determined to have elapsed, initiating the acquiring of one of said available scanned channels for a predetermined occupancy time.

In some embodiments, said means is configured to determine that a second predetermined period of time has elapsed since said channel was acquired prior to initiating said scanning, said second predetermined period of time being less than said predetermined period of time.

In some embodiments, said second predetermined period of time is specific to a particular channel.

In some embodiments, said means is configured to determine said second predetermined time for said at least one further channel to be scanned in dependence upon at least one of: a determined channel load and channel occupancy of said at least one further channel; and stored historical data of a latency time between a scan commencing on said at least one further channel and said at least one further channel being determined to be available.

In some embodiments, said predetermined time is selected in dependence upon a desired overlap of said occupancy times.

In some embodiments, said means is configured to control said apparatus to perform an initial step of at least one of: initiating transmission of an indication to said further apparatus that multiple channel communication within the unlicensed spectrum between said apparatus and said further apparatus is to be performed; and receiving an indication from said further apparatus that multiple channel communication within the unlicensed spectrum between said apparatus and said further apparatus is to be performed.

In some embodiments, said means is configured: on acquiring said one of said available scanned channels to initiate transmitting of a signal requesting an uplink transmission from said further apparatus; and where said uplink transmission is not received within a set time: to select a further one of said scanned available channels and to initiate transmitting to acquire said further one of said scanned available channels for a predetermined occupancy time period; and to mark said one of said available scanned channels as unavailable.

In some embodiments, said predetermined time is selected to provide a set overlap period for said occupancy times, said step of selecting and acquiring said further one of said scanned available channels being performed within said set overlap period.

In some embodiments said means is configured during said predetermined occupancy period to initiate transmission of a signal indicating a further channel that is to be used during a subsequent predetermined occupancy period of said communication.

In some embodiments, where said apparatus is configured to control the acquiring of the channels and where the further apparatus can only communicate on one channel at one time, then the apparatus may be configured to indicate to the further apparatus a subsequent channel that is to be acquired next during the current channel occupancy period. In this way the other apparatus can switch to this channel to receive subsequent signals at or towards the end of the current channel occupancy period.

In some embodiments, the means comprises: at least one processor; and at least one memory including computer program code, said at least one memory and computer program code being configured to, with said at least one processor, cause the performance of the apparatus.

In some embodiments, said apparatus further comprising means for transmitting and receiving signals, and means for scanning channels in unlicensed spectrum.

According to various, but not necessarily all, embodiments of the invention there is provided an apparatus comprising: control circuitry configured to: determine that a channel in unlicensed spectrum has been acquired by said apparatus or by a further apparatus for a predetermined occupancy time, said channel being one of a plurality of channels within said unlicensed spectrum; initiate scanning of at least one further channel within said unlicensed spectrum to determine if said scanned at least one further channel is available; determine whether a predetermined time has elapsed since said channel was acquired, said predetermined time being less than or equal to said predetermined occupancy time; and following said scan indicating that at least one of said scanned at least one further channels is available, and when said predetermined time is determined to have elapsed, initiating the acquiring of one of said available scanned channels for a predetermined occupancy time.

In some embodiments, said apparatus further comprises a transmitter configured to transmit signals towards said at least one further node in a plurality of channels of the unlicensed spectrum; a receiver configured to receive signals from said at least one further node in a plurality of channels of the unlicensed spectrum; scanning circuitry configured to scan said plurality of channels in the unlicensed spectrum.

In some embodiments, said control circuitry is configured to determine that a second predetermined period of time has elapsed since said channel was acquired prior to controlling said scan, said second predetermined period of time being less than said predetermined period of time.

In some embodiments, said control circuitry is configured to determine said second predetermined time for said at least one further channel to be scanned in dependence upon at least one of: a determined channel load and channel occupancy of said at least one further channel; and stored historical data of a latency time between a scan commencing on said at least one further channel and said at least one further channel being determined to be available.

In some embodiments, said control circuitry is configured to control said apparatus to perform an initial step of at least one of: initiating transmission of an indication to said further apparatus that multiple channel communication within the unlicensed spectrum between said apparatus and said further apparatus is to be performed; and receiving an indication from said further apparatus that multiple channel communication within the unlicensed spectrum between said apparatus and said further apparatus is to be performed.

According to various, but not necessarily all, embodiments of the invention there is provided a method and apparatus for providing communication between nodes, the nodes consecutively using different sub-bands within unlicensed spectrum. The acquiring of the sub-bands is arranged such that there is at least some overlap of the occupancy of the sub-bands and any gaps in the communication are inhibited. A method is provided that is performed at a second node of co-ordinating multiple channel communication between a first and second node, the method comprising: while communicating with said first node on a first channel scanning at least one further channel to determine if at least one further channel is available, after a predetermined time acquiring one of said at least one further scanned channels prior to an occupancy period of said first channel expiring. The method further comprising transmitting a signal on said first channel to said first node indicating said at least one further channel that is to be acquired during said channel occupancy period.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

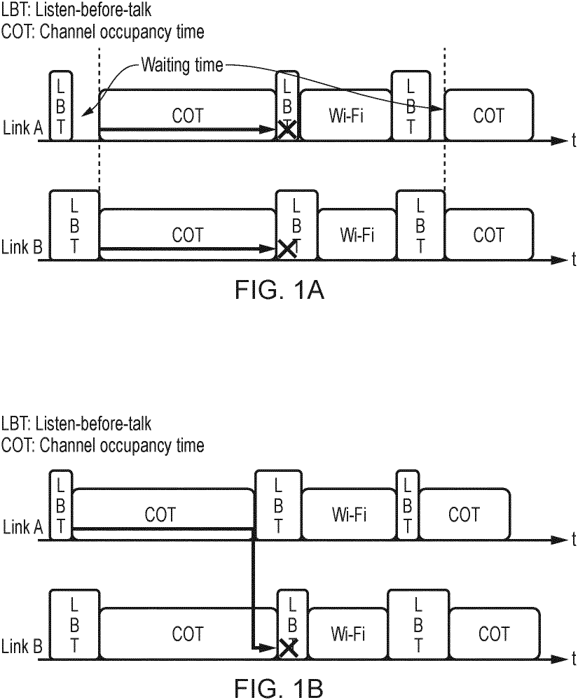

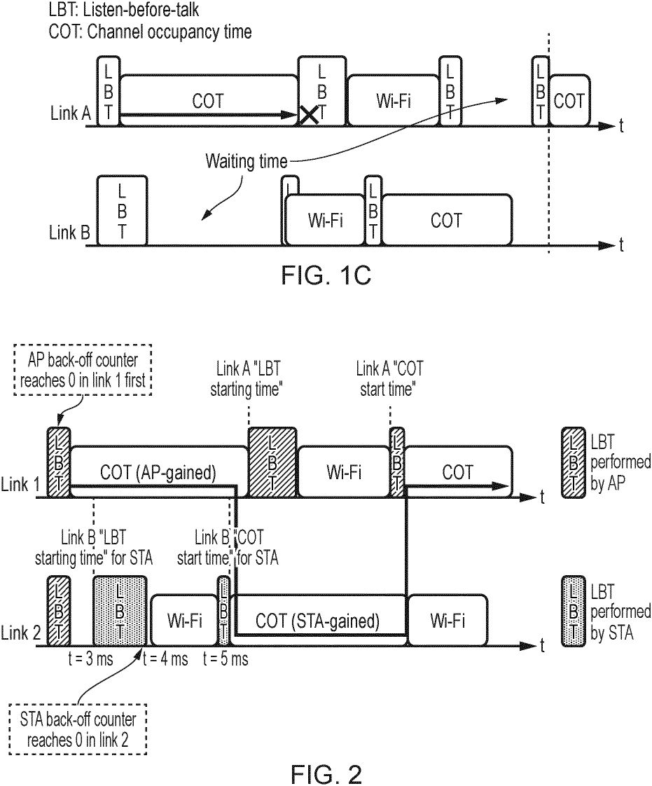

FIGS. 1a, 1b and 1C illustrate problems with discontinuous communication that may arise with multiple link communication;

FIG. 2 schematically illustrates a multi link communication according to an embodiment;

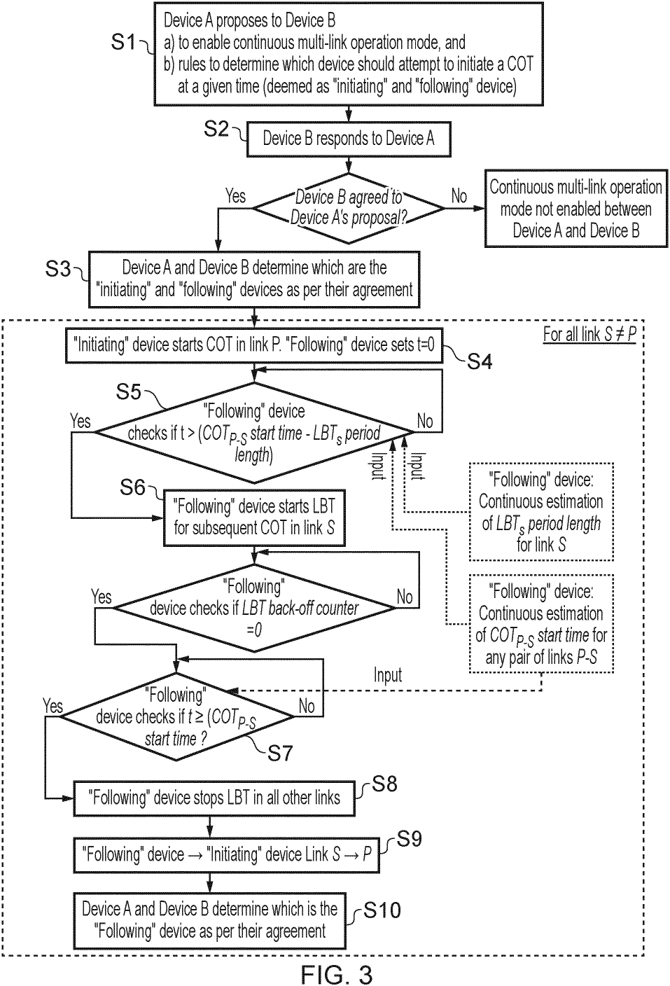

FIG. 3 shows a flow diagram illustrating steps in a method of performing multi link communication according to an embodiment;

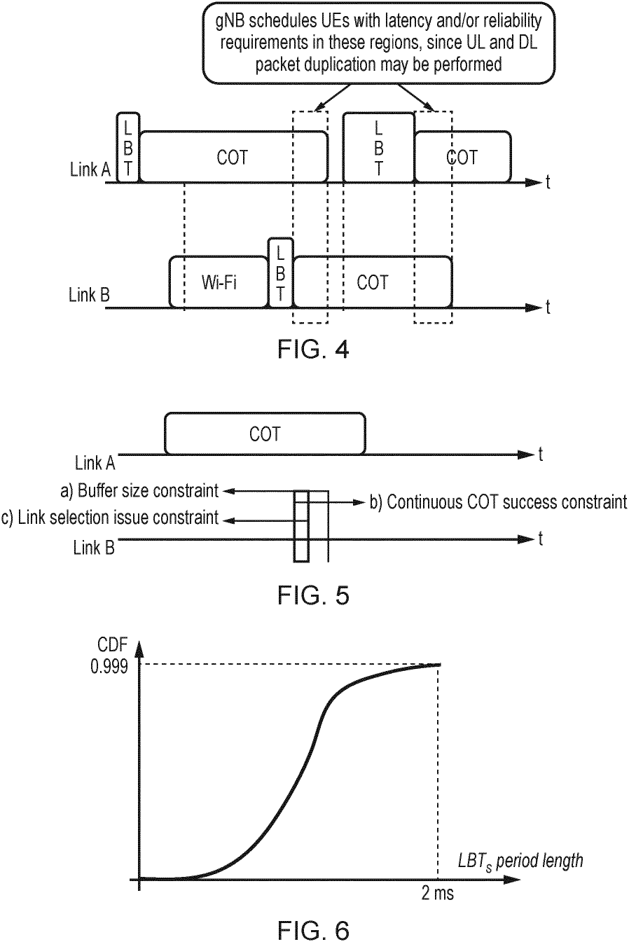

FIG. 4 schematically illustrates a multi link communication according to a further embodiment;

FIG. 5 schematically illustrates constraints on the timing of the start of a COT in a further channel;

FIG. 6 schematically illustrates the scanning time required to find an available channel; and

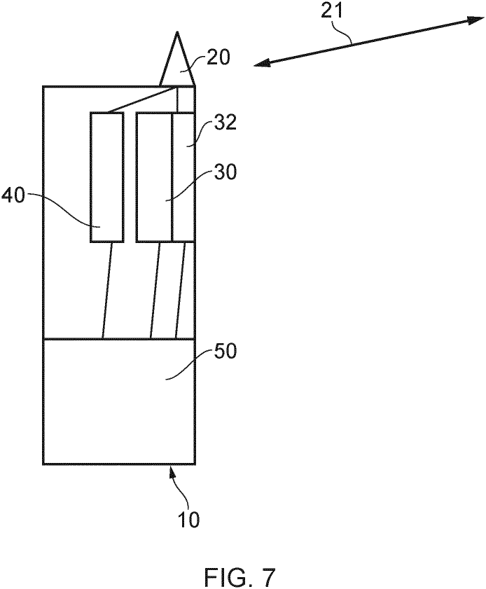

FIG. 7 schematically shows a node according to one embodiment.

### DETAILED DESCRIPTION

Before discussing the example embodiments in any more detail, first an overview will be provided.

Embodiments provide apparatus or nodes configured to communicate using multiple channels in the unlicensed spectrum in a way such that latency in the transmissions is reduced and discontinuities are inhibited. Communication between nodes is performed consecutively on different channels in the unlicensed spectrum.

Coordination of the acquiring of the different channels is provided so that a further channel is acquired prior to the occupancy time of the currently used channel expiring.

In some embodiments, a node receiving signals from a further node in a first channel that the further node has acquired for an occupancy period, scans one or more other channels during this occupancy period, and when it determines that one of the scanned other channels is available and when the occupancy period of the acquired channel is soon to expire, the node acquires the available channel and in this way communication between the two nodes can continue without interruption or at least with reduced chances of interruption. In this regard, where multiple channels are scanned and where the loading of the channels is not unduly high, then it is highly likely that a channel will be available and can be acquired during the occupancy period of the previously acquired channel so that no gaps in transmission will occur.

In other embodiments, one of the nodes in the communication may be in control of the acquiring of the channels. In one example the node may be a gNB (5G radio node) communicating with user equipment. In such a case the gNB is in control of the acquiring of the different channels and it will scan multiple channels during the occupancy period of a previously acquired channel and will acquire a channel in the unlicensed spectrum before the occupancy period the previously acquired channel expires. In this way by controlling the timing of the scans and the timings of the acquiring of the channels, continuous communication using different channels within the unlicensed spectrum may be achieved.

FIGS. 1A, 1B and 1C illustrate potential problems that may arise with latency where there is no coordination with the acquiring of different channels within the unlicensed spectrum in communication between two nodes. In FIG. 1A a synchronous multi-link channel access is shown where multi-link devices control channel access to ensure that channel occupancy times (COTs) in different links a) start simultaneously, and/or b) finish simultaneously. From a channel access perspective, the implementation of a synchronous multi-link channel access leads to an almost-certain discontinuous communication (see crosses in FIG. 1A), since the relevant links must be simultaneously available.

An alternative may be asynchronous and independent multi-link channel access which is shown in FIG. 1B. A device implementing this mode of operation will perform channel access independently on a per-link basis, i.e., a multi-link device will initiate a COT whenever a link is available. It should be noted that the COTs in different links may be started by different devices. For instance, while the diagram covers a number of scenarios, one could think of a gNB (gNB₁) initiating the first COT in Link A to communicate with one of its associated UEs (UE₁), and UE₁ initiating the first COT in Link B to communicate with gNB₁. Accordingly, this may provide a high throughput. However, this mode of operation may not be the most efficient from a latency-related perspective since, almost certainly, there will be periods without a COT (see cross in FIG. 1B) due to the independent channel access rules per link. Also, depending on the transceiver implementation, as well as on whether the links are in the same band and/or there is enough frequency separations between the links, a device may be unable to perform LBT on one link while transmitting and/or receiving on another link. This makes the above observation even more true.

FIG. 1C shows alternating multi-link channel access, where a multi-link device attempts channel access in a different link only once the active COTs in other links have finished. While this mode of operation may be the best alternative from a latency perspective if devices cannot transmit/receive simultaneously in different links, it may not be the optimal approach if devices do not have such a constraint. This is because this mode of operation does not guarantee having at least one COT ongoing/available at any time when interferers are present (see cross in FIG. 1C).

FIG. 2 schematically show the timing of the scanning and acquiring of channels by two nodes according to an embodiment. As illustrated by the arrow in FIG. 2, the objective of the proposed solution, which is referred to as “continuous multi-link operation mode”, is to have at least one COT ongoing/available at any time.

In the FIG. 2 example the communication is between a 802.11-compliant access point (AP) with multi-link capabilities and a 802.11-compliant augmented/virtual reality station (STA) with multi-link capabilities. Embodiments are particularly applicable to augmented/virtual reality traffic which imposes tight latency/reliability constraints that should be satisfied for a satisfactory end-user experience.

Although the example for an AP and STA is given above, the communication could be between any two nodes configured to communicate using multiple channels in the unlicensed spectrum. For example, the communication may be a cellular sidelink communication, where a cellular device communicates directly with another without relaying its traffic via a base station. In this setting, one of the devices will take the role of AP (and therefore become the leading device) while the other device takes the role of STA. These roles can of course be interchanged as the communication progresses, especially if both devices cannot transmit-and-receive simultaneously in multiple links due to self-interference/hardware constraints. For these devices to establish the described operation in a sidelink context, explicit signalling is used.

For the purposes of this embodiment, a link can be interpreted as a 20 MHz channel, the multi-link AP and the multi-link STA operate in two links (link 1 and link ₂) located in different frequency bands (e.g., low-5 GHz and high-5 GHz). The device (AP or STA in this embodiment) that initiates the COT will perform a continuous data transmission towards the other communication end for which, the maximum COT duration is 6 ms. FIG. 3 show a flow diagram illustrating steps in a method according to an embodiment. In this example, “Device A” is the AP, whereas “Device B” is the STA.

Step S1: After identifying the traffic requirements of the STA, the AP indicates to the STA:
that it should enable continuous multi-link operation mode, and
that the AP itself will be the “initiating” device in the first transmission of the continuous multi-link operation mode and that the “following” device should be the one receiving data in link P. In practice, this means that the role of “following” device will alternate between the AP and the STA, and that both devices should implement components of the proposed method.

Where the devices are two UEs communicating directly then in a sidelink context, the device taking the role of AP, signals the device taking the role of STA the behaviour described above. As this behaviour requires a configuration between both devices, then in some embodiments, it is done via a PC₅ RRC Reconfiguration messaging exchange (where the PC5 denotes the sidelink interface between the two devices and the RRC Reconfiguration message corresponds to the Radio Resource Control messaging, which in the cellular context is responsible for all configuration parameters and their exchange between affected devices).

Step S2: The STA (device B) replies to the AP (device A) indicating that it agrees to operate in the continuous multi-link operation mode.

In the sidelink context step S2 is equivalent to the device taking the role of STA, replying with a PC5 RRC Reconfiguration Acknowledgement (which in practice just requires a HARQ Ack to be received).

Provided that device B accepts the multi-link operation mode then at step S3: it is determined who will be the initiating and who the following device initially. In this case, the AP will be the “initiating” device in the first COT, and the STA will be the “following” device in the first COT.

Step S4: after contending for channel access with LBT in both links, the AP obtains a COT and initiates a downlink transmission towards the STA in link 1, which is now labelled as “link P”. As the “following” device, the STA initializes the COT timer to t = o.

Where the two devices are directly communicating UEs, in order to inform the device taking the role of STA, the device taking the role of AP includes control information in its transmission. Such control information at least states that the AP device has acquired the COT and for which duration.

Step S5: Since the STA has been deemed as the “following” device, it checks if it should start its scan yet. It determines that it should when:

$$\text{t >} \left({\text{COT}}_{\text{P-S}} {\text{start time - LBT}}_{\text{S}} \text{period length}\right) \text{, for all S} \neq \text{P}$$

The above operation must be independently performed for the link S = 2, COT_{P-S} is defined as the time-starting from the moment the COT in Link P started― from which a multi-link device is allowed to initiate a transmission in a different link (Link S). This depends on how long any desired overlap of the two COTs is.

The value of this parameter varies depending on the pair of links under consideration, i.e., Link P and Link S, are different per device, and should be dynamically and independently adjusted by the relevant device/s—both the AP and the STA in this embodiment.

LBTₛ is defined as the time spent by a device between 1) the start of the channel access contention in link S, and ₂) the start of a transmission in link S. The “LBT period length” therefore includes the time such device 1) senses the channel free with the back-off counter equal to a non-zero value, and the ₂) time one senses the channel occupied.

In effect, it is determined from the length of the COT and from the estimated time that a scan of the channel can be performed in and a channel deemed available, at which time the scan process should be started to make it likely that the channel will be available. The time that a scan of a particular channel should have completed by may be estimated from the history of the channel and/or the current loading and/or channel occupancy and that time is denoted LBTs for a channel s. Thus, the scan of a particular channel is started when it is estimated that the COT has this time left, so that the scan should have completed prior to the end of the COT, or rather at the point that a multi link device is allowed to start a transmission in another link.

In other simpler embodiments, the device will continuously perform LBT and this parameter may not be utilized.

In this embodiment, we consider that devices that have the capability of implementing the proposed mode of operation incorporate functional blocks that continuously estimate both the COT_{P-S} start time and the LBTₛ period length parameters, even when the continuous multi-link operation mode is not active. This allows them to provide initial estimates, which can be then refined as described later.

For illustrative purposes, let us assume that (COT_{P-S} start time - LBT_{S} period length) = 3 ms, and that COT_{P-S} start time = 5 ms. Therefore, the STA proceeds to Step S6 once t = 3 ms.

At step S6 the STA starts LBT in the link S= 2 at t = 3 ms.

In step S7: when the LBT back-off counter reaches o in link S= 2, the STA which is currently the following device checks if

$$\text{t} \geq {\text{COT}}_{\text{P-S}} \text{start time}$$

For illustrative purposes, and since this is a random process, let us assume that the LBT counter of the STA reached o at t = 4 ms for link S= 2. This means that the device must wait for 1 ms before proceeding to Step S8.

Step S8: When t = 5 ms, the STA makes sure that link S= 2 is still deemed as free. In embodiments where the following device scanned more than one channel, that is at step S6 it started LBT in more than one link (say S2, S3 and S4), then at step S8 the device will stop LBT scanning in the other links (see description of NR-U compliant gNB below).

Step S9: The STA becomes the “initiating” device and link S= 2 is now labelled as link P.

Step S10: As per the initial agreement between the AP and the STA, the AP will adopt the role of “following” device next, since it is receiving data in link P. The STA proceeds back to Step S4 as the initiating device.

Sidelink aspects: This agreement is part of the exchange PC5 RRC reconfiguration.

In a different embodiment, we consider a scenario with a NR-U-compliant gNB with multi-link capabilities and two NR-U-compliant UEs, namely one augmented/virtual reality UE with multi-link capabilities and one UE generating best effort traffic.

For the purposes of this embodiment,
a link can be interpreted as a 20 MHz channel,
the multi-link gNB and the multi-link UEs operate in four links (link 1 to 4) within the same frequency band (e.g., low-5 GHz),
the maximum COT duration is 6 ms,
the multi-link UE has simultaneous transmit-and-receive constraints, i.e. it cannot receive in one link and transmit in a different link simultaneously due to in-device inter-channel interference,
the serving gNB is aware of such simultaneous transmit-and-receive constraints, and
“Device A” in FIG. 3 will be the gNB, whereas “Device B” in FIG. 3 will be the UE.

For ease of description, in the following we focus on the differences and additions of this embodiment with respect to the previous embodiment.

Step S1: After identifying the traffic requirements of the associated UEs, the gNB proposes the augmented/virtual reality UE to enable the continuous multi-link operation mode, and that the gNB itself will always be both the “initiating” and the “following” device.

Step S2: The augmented/virtual reality UE replies to the AP indicating that it agrees to operate in the continuous multi-link operation mode.

Step S3: As per the agreement, the gNB will adopt the role of both the “initiating” and the “following” device in the first COT.

Step S4: After contending for channel access with LBT in all four links, the gNB obtains a COT and initiates a downlink transmission towards the best effort UE in link 1, which is now labelled as “link P”. As the “following” device, the gNB initializes the COT timer to t = o.

FIG. 4 shows how the transmission(s) towards/from the multi-link-capable UEs with strict latency/reliability/throughput requirements may be scheduled at the beginning of the COT and/or after the COT start time of link P, since these UEs will benefit from the possibility of duplicating/aggregating data in different links. This also provides the time for single-link-capable UEs to switch from link A to link B based on signalling received in the COT on Link A. Such mechanism could be based on standardized signalling to support BWP (band width part) switching in 5G NR, or alternative methods.

In other embodiments, the gNB may decide to stop the COT obtained in link P immediately upon obtaining a COT in link S.

Step S5: Since the gNB has been deemed as the “following” device, it checks if

$$\text{t >} \left({\text{COT}}_{\text{P-S}} {\text{start time - LBT}}_{\text{S}} \text{period length}\right) \text{, for all S} \neq \text{P}$$

where the above operation is independently performed for links S = 2, S = 3, and S = 4.

For illustrative purposes, let us assume that (COT_{P-S} start time - LBT_{S} period length) = 3 ms for all links, and that COT_{P-S} start time = 5 ms. Therefore, the gNB proceeds to Step S6 once t = 3 ms.

Step S6: The gNB starts LBT in the links S= {2, 3, 4} at t = 3 ms.

Step S7: When the LBT back-off counter reaches o in links S= {2, 3, 4}, the gNB checks if

$$\text{t} \geq {\text{COT}}_{\text{P-S}} \text{start time}$$

For illustrative purposes, and since this is a random process, let us assume that the LBT counter of the gNB reached o at t = 5 ms for links S= {2, 3. 4}.

Step S8: When t = 5 ms, the gNB makes sure that links S= {2, 3, 4} are still deemed as free. The gNB decides randomly to initiate a transmission in link S= 2 and stops the LBT in the other links. In this regard, since the gNB can initiate a COT in multiple links, the gNB may select where to initiate the COT based on, e.g., a random choice or a predefined channel selection metric.

Step S8.1. (not shown): The AP performs uplink and downlink transmissions in link S= 2 from/towards the augmented/virtual reality UE before the end of the COT.

If the scheduled UEs perform the requested uplink transmission(s), go to Step S9.

If the scheduled UE do not perform the requested uplink transmission (e.g., due to the presence of hidden devices), the gNB may determine that link S= 2 is not appropriate and, if at least there is enough time before the end of the COT in Link P and, considering the carrier sense status in other links-for instance, whether they are available or about to be available-, it will
consider link S= 2 as unavailable and remove it from the list of candidate links, and
re-execute to Step S8. In this instance, the gNB decides to initiate a transmission in link S= 3.

Step S9: Link S= 3 is now labelled as link P.

Step S10: The gNB proceeds back to Step 4.

FIGS. 5 and 6 show schematically how the predetermined time at which the next channel is acquired COT_{P-S} start time and how the length that it is estimated is required for the LBT scan which sets the second predetermined time at which the channel scan is started may be determined.

The COT_{P-S} parameter will determine the overlap of the COTs when switching between links. FIG. 5 shows the different facts that affect it and how they increase or decrease the overlap of the COTs.

In preferred embodiments, devices implementing the proposed method will adjust this parameter accounting for:
the downlink/uplink buffer sizes (i.e., traffic load)—which set a constraint in the minimum COT overlapping to deliver a given throughput;
the specific value of required COT overlapping to deliver a given amount of data can be readily computed based on the aggregate transmission/reception time across all active links;
the previous success rate of guaranteeing continuous COTs when transitioning from link S to any other link - for instance, a smaller COT start time may lead to a smaller success rate of guaranteeing continuous COTs, since the COTs in different links would finalize at similar times and there would be a smaller likelihood of having at least one COT immediately after. In some embodiments, a variety of predefined COT start times may be available and tested before picking the value that maximizes or at least improves the above-mentioned success rate;
the required time to detect link selection issues and allows fast reselection (see Additional Step 8.1 in the second embodiment) - for instance, some embodiments may perform an uplink and a downlink transmission at the beginning of the partially overlapping COT to determine if there are any issues with the initial link selection attempt and a new link should be selected.

FIG. 6 illustrates how the value of the parameter LBTₛ period length may be determined to provide for a desired probability that a scanned channel will be available at the desired COT start time. While the value of the LBTs parameter varies from one embodiment to another and depends on the specific link or channel under consideration, it should be noted that its value will depend on the channel load and occupancy. In general, devices can generate a conservative bound based on, e.g., previous channel access statistics, and use it to start LBT—considering the current back-off counter value-at the most appropriate time point to achieve the desired COT start time.

In some embodiments, the device implementing the proposed method will determine the value of LBTₛ period length for all links where the device operates based on previous statistics of the LBT durations on a per-link basis. For instance, as illustrated in FIG. 10, the device may select the value that guarantees with a given probability (0.999 in the figure) that the LBT will be successful within the listening period (2 ms).

In other embodiments the device implementing the proposed method will determine the value of LBTs for all links where the device operates based on joint statistics of the LBT durations on multiple links. For instance, if the device can perform LBT in 3 links simultaneously, the device may select the value that provides a given probability that the LBT in at least one link will be successful within the listening period

In summary embodiments provide nodes that establish an agreement between the nodes that specifies which node/s should attempt to initiate a COT at a given time.

Embodiments define and adjust link-dependent “COT start times”, so that COTs in different links do not start too close to each other.

Embodiments provide that a new COT can only start after a time period-which is adjusted to increase the chances that at least one COT is available at any time-after the beginning of the current COT.

Embodiments control the “LBT start times” per link by taking into account the expected “LBT period length” and the “COT start times”.

Embodiments control the “LBT period length” in dependence upon the channel load and occupancy. The LBT period length may be estimated and the LBT started at the most appropriate time point to achieve the desired COT start time.

Both end-user devices and infrastructure network components may implement components of the invention.

FIG. 7 illustrates an apparatus according to an embodiment. The apparatus is a network node 10 configured to transmit and receive signals 21 on multiple channels within the unlicensed spectrum and may for example be an access point, a user equipment, a gNB or a station. Node 10 comprises transmit circuitry 30 and receive circuitry 32 which are configured to transmit and receive signals on multiple channels of the unlicensed spectrum via antenna 20. The node 10 comprises scanning circuitry 40 configured to scan the multiple channels in the unlicensed spectrum using a listen before talk procedure to determine whether they are available. In other embodiments other scanning circuitry that uses other scanning procedures such as a clear channel assessment may be used.

Node 10 comprises control circuitry that is configured to control the transmit, receive and scanning circuitry to perform a method such as that illustrated in FIG. 3 whereby the node communicates with another node using different channels within the unlicensed spectrum. The node may acquire a first channel itself, or may receive signals from another node on the first channel acquired by that node, at which point it may scan for an available other channel in the unlicensed spectrum and then acquire that other channel prior to the expiry of the COT period of the first channel, such that communication between the nodes may continue without gaps.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method performed at an apparatus, said method comprising:
determining at said apparatus that a channel in unlicensed spectrum has been acquired by said apparatus or by a further apparatus for a predetermined occupancy time, said channel being one of a plurality of channels within unlicensed spectrum;
initiating a scan of at least one further channel within said unlicensed spectrum to determine if said scanned at least one further channel is available;
determining whether a predetermined time has elapsed since said channel was acquired, said predetermined time being less than or equal to said predetermined occupancy time; and
following said scan indicating that at least one of said scanned at least one further channels is available, and when said predetermined time is determined to have elapsed, initiating the acquiring of one of said available scanned channels for a predetermined occupancy time.

2. The method according to claim 1, said method comprising prior to initiating said scan determining whether a second predetermined period of time has elapsed since said channel was acquired, and when said second predetermined time is determined to have elapsed initiating said scan, said second predetermined period of time being shorter than said predetermined period of time.

3. The method according to claim 2, wherein a value of said second predetermined period of time is specific to a particular channel.

4. The method according to claim 3, said method comprising determining said second predetermined time for said at least one further channel to be scanned in dependence upon at least one of:
a determined channel load and channel occupancy of said at least one further channel; and
stored historical data indicative of a latency between a scan commencing and said at least one further channel being determined to be available.

5. The method according to claim 1, said predetermined time being selected in dependence upon a desired overlap of said occupancy times.

6. The method according to claim 1, said apparatus performing an initial step of at least one of:
initiating transmission of an indication to said further apparatus that multiple channel communication within the unlicensed spectrum between said apparatus and said further apparatus is to be performed; and
receiving an indication from said further apparatus that multiple channel communication within the unlicensed spectrum between said apparatus and said further apparatus is to be performed.

7. The method according to claim 1, wherein
said determining at said apparatus that a channel in the unlicensed spectrum has been acquired by said apparatus or by said further apparatus comprises acquiring said channel, said method further comprising:
repeating said initiating scanning of said channels and acquiring available scanned channels for a predetermined occupancy time a plurality of times during a period of multiple channel communication between said apparatus and said further apparatus.

8. The method according to claim 7, said method further comprising:
on acquiring said one of said available scanned channels, requesting an uplink transmission from said further apparatus; and
where said uplink transmission is not received within a set time:
selecting a further one of said scanned available channels and acquiring said further one of said scanned available channels for a predetermined occupancy time period; and
marking said one of said available scanned channels as unavailable.

9. The method according to claim 8, wherein said predetermined time is selected to provide a set overlap period for said occupancy times, said step of selecting and acquiring said further one of said scanned available channels being performed within said set overlap period.

10. The method according to claim 1, wherein
said step of determining at said apparatus that a channel in the unlicensed band has been acquired by said apparatus or by said further apparatus for a predetermined occupancy time comprises receiving a signal from said further apparatus indicating that said further apparatus has acquired said channel.

11. The method according to claim 10, said method comprising:
following acquiring said scanned available channel transmitting an indication to said further apparatus that said scanned available channel has been acquired for a predetermined occupancy time; and
receiving a signal from said further apparatus indicating that said further apparatus has acquired a further one of said plurality of channels in the unlicensed spectrum prior to or on said predetermined occupancy time that said scanned available channel was acquired for expiring.

12. The method according to claim 1, comprising performing a further check that said scanned available channel is still available immediately prior to initiating the acquiring of said channel.

13. A computer program comprising computer readable instructions which when executed by a processor on an apparatus are configured to cause said apparatus to perform a method according to claim 1.

14. An apparatus comprising:
at least one processor; and
at least one memory including computer program code, said at least one memory and computer program code being configured to, with said at least one processor, cause the apparatus at least to:
determine that a channel in unlicensed spectrum has been acquired by said apparatus or by a further apparatus for a predetermined occupancy time, said channel being one of a plurality of channels within said unlicensed spectrum;
initiate scanning of at least one further channel within said unlicensed spectrum to determine if said scanned at least one further channel is available;
determine whether a predetermined time has elapsed since said channel was acquired, said predetermined time being less than or equal to said predetermined occupancy time; and
following said scan indicating that at least one of said scanned at least one further channels is available, and when said predetermined time is determined to have elapsed, initiating the acquiring of one of said available scanned channels for a predetermined occupancy time.

15. The apparatus according to claim 14, said wherein said at least one memory and said computer code are configured to, with said at least one processor, cause the apparatus at least to determine that a second predetermined period of time has elapsed since said channel was acquired prior to initiating said scanning, said second predetermined period of time being less than said predetermined period of time.

16. The apparatus according to claim 15,wherein said second predetermined period of time is specific to a particular channel.

17. The apparatus according to claim 16, wherein said at least one memory and said computer code are configured to, with said at least one processor, cause the apparatus at least to determine said second predetermined time in dependence upon at least one of:
a determined channel load and channel occupancy of said at least one further channel; and
stored historical data of a latency time between a scan commencing on said at least one further channel and said at least one further channel being determined to be available.

18. The apparatus according to claim 14, wherein said predetermined time is selected in dependence upon a desired overlap of said occupancy times.

19. The apparatus according to claim 14, wherein said at least one memory and said computer code are configured to, with said at least one processor, cause the apparatus at least to perform at least one of:
initiating transmission of an indication to said further apparatus that multiple channel communication within the unlicensed spectrum between said apparatus and said further apparatus is to be performed; and
receiving an indication from said further apparatus that multiple channel communication within the unlicensed spectrum between said apparatus and said further apparatus is to be performed.

20. The apparatus according to claim 19 wherein, said at least one memory and said computer code are configured to, with said at least one processor, cause the apparatus at least to:
on acquiring said one of said available scanned channels to initiate transmitting of a signal requesting an uplink transmission from said further apparatus; and
where said uplink transmission is not received within a set time:
te-select a further one of said scanned available channels and to initiate transmitting to acquire said further one of said scanned available channels for a predetermined occupancy time period; and
te-mark said one of said available scanned channels as unavailable.

21. The apparatus according to claim 20, wherein said predetermined time is selected to provide a set overlap period for said occupancy times, and wherein said at least one memory and said computer code are configured to, with said at least one processor, cause the apparatus at least to control said selecting and acquiring of said further one of said scanned available channels to be within said set overlap period.

22. (canceled)

23. The apparatus according to claim 14, said apparatus further comprising transmit circuitry configured to transmit signals, receive circuitry configured to receive signals, and scan security configured to scan channels in unlicensed spectrum.
